(19) United States
(12) Patent Application Publication
(10) Pub. No.: US 2005/0094700 A1
(43) Pub. Date: May 5, 2005

(54) Apparatus for generating a laser structured line having a sinusoidal intensity distribution

(75) Inventors: Chun-Hung Ko, Hemei Township (TW); Hsin-Yueh Sung, Yonghe City (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Jhudong Township (TW)

(21) Appl. No.: 10/975,365

(22) Filed: Oct. 29, 2004

(30) Foreign Application Priority Data
Oct. 31, 2003 (TW) 092130458

(51) Int. Cl. H01S 3/08

(52) U.S. Cl. 372/98; 372/26

(57) ABSTRACT

A apparatus for generating a structured line having a sinusoidal intensity distribution is disclosed. The apparatus comprises a coherent light source and a diffractive optical element. The coherent light source provides an incident light beam to the diffractive optical element, the incident light beam being modulated by means of the diffractive optical element to form a fringe pattern of sinusoidal intensity distribution. The diffractive optical element design is optimized in accordance with the optical field distribution of an incident-light-beam plane and the optical field distribution of an output-light-beam plane.

### BACKGROUND OF THE INVENTION

1. Field of the Invention

The present invention relates to a projection apparatus, and more particularly, to a apparatus for generating a laser structured line having a sinusoidal intensity distribution.

2. Description of Related Art

Interference-fringe pattern of sinusoidal intensity distribution is the most widely-used projected pattern in the mechanical interference apparatus due to its capability of measuring the three-dimensional surface profiling of an object. However, it is difficult to obtain the projected pattern. The projection apparatus for generating the projected pattern or related apparatus to the projected apparatus is too bulky in size, and also, the illumination efficiency thereof is low.

At present, the interference-fringe pattern of sinusoidal intensity distribution is generated with a projection apparatus by one of the following ways: projecting a fringe pattern of sinusoidal intensity distribution with the Twyman-Green interferometer or an alternative interferometer, which tilts at an angle; projecting a fringe pattern of sinusoidal intensity distribution with a laser, a beam expander and a transmission one-dimensional sinusoidal amplitude grating; projecting a fringe pattern of qiasi-sinusoidal intensity distribution with a projection equipment, a Ronchi Rulling grating and a defocus projection lens; or projecting a fringe pattern of sinusoidal intensity distribution with a projection equipment and a transmission sinusoidal grating of one-dimensional amplitude.

Therefore, it is a dire need to provide a projection apparatus for generating a interference-fringe pattern of sinusoidal intensity distribution, which is simply-constructed, optically high-efficient and less expensive.

### SUMMARY OF THE INVENTION

An object of the present invention is to provide a apparatus for generating a structured line having a sinusoidal intensity distribution so as to present a small-sized, light-weighted and high efficiency projection apparatus capable of projecting a fringe pattern of sinusoidal intensity distribution.

To attain the above-mentioned object, a apparatus for generating a structured line having a sinusoidal intensity distribution according to the present invention includes a coherent light source for providing a coherently incident light beam and can be a gas laser, a diode laser, a vertical cavity surface emitting laser (VCSEL), a solid-state laser, a diode pumping solid-state laser, a dual frequency or multi-frequency laser, a dye laser, or a single-mode or multimode laser; at least a diffractive optical element for shaping said coherent light beam to an output beam having a sinusoidally varying intensity distribution through an proper diffractive optical design (Ex. IFTA method or another) and can be a phase relief diffractive optical element, an amplitude diffractive optical element, a hologram optical element, a volume hologram optical element or a computer generated hologram; wherein the at least one diffractive optical element is designed based on an optimal mathematical model, the optical mathematical model comprises a patterned relief surface of a phase diffractive optical element providing a phase modulation function, an incident-light-beam plane providing a first wave function and an output-light-beam plane providing a second wave function so that a conversion function exists for a transformation between said first wave function and said second wave function and a error function indicates a difference between said second wave function and the mathematical product of said first wave function and said conversion function, and said error function is mathematically calculated by the optimal mathematical model to generate a patterned relief surface through which said coherent light beam is modulated to project a fringe pattern of sinusoidal intensity distribution onto said output-light-beam plane.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of the construction of an embodiment according to the present invention;

FIG. 2 is a schematic diagram of a diffractive optical design of a phase diffractive optical element of an embodiment according to the present invention;

FIG. 3 illustrates a patterned relief surface as a result of a simulation of an embodiment according to the present invention;

FIG. 4 is a cross-sectional view of a patterned relief surface along the x-axis as a result of a simulation of an embodiment according to the present invention;

FIG. 5 is a cross-sectional view of an actual patterned relief surface along the x-axis of an embodiment according to the present invention;

FIG. 6 is a cross-section view of an optimal fringe pattern of sinusoidal intensity distribution along the x-axis of an embodiment according to the present invention;

FIG. 7 is a cross-section view of a fringe pattern of sinusoidal intensity distribution along the x-axis as a result of a simulation of an embodiment according to the present invention; and

FIG. 8 schematically illustrates the shape of various fringe patterns of sinusoidal intensity distribution of a preferred embodiment according to the present invention.

### DETAILED DESCRIPTION OF THE PREFERRED EMBODIMENT

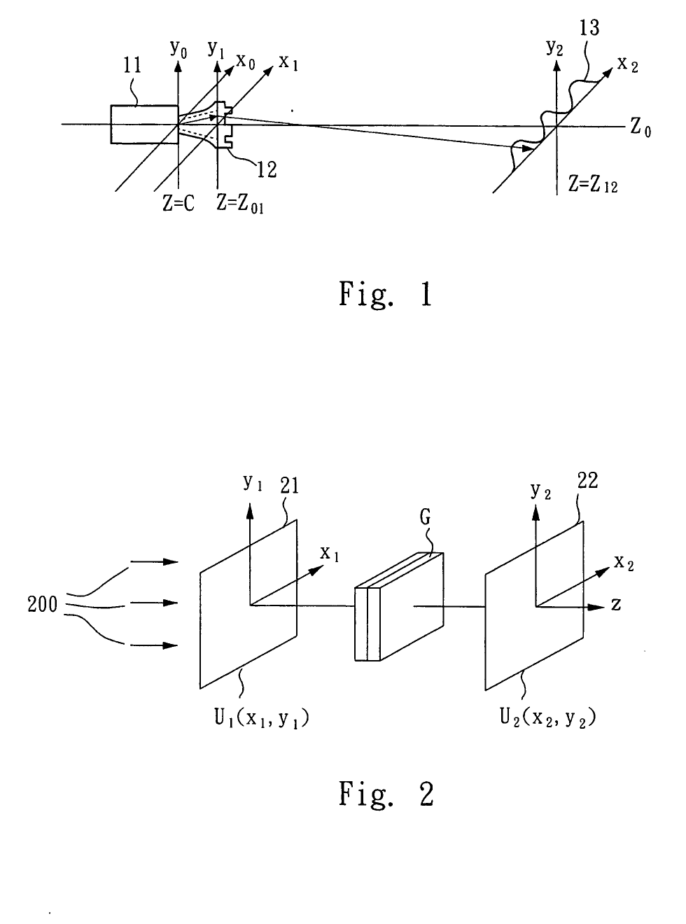

An apparatus as illustrated in FIG. 1 schematically showing an implementation of the present invention is constructed primarily by a coherent light source 11 and a diffractive optical element 12. The coherent light source 11 provides an incident light beam to the phase diffractive optical element 12 so as to project a fringe pattern 12 of sinusoidal intensity distribution. The diffractive optical element 12 is a well known element and published in a reference titled “Diffractive-phase-element design that implements several optical functions”, Applied Optics, Vol. 34, No.14, 1995, the authors are Ben-Yuan Gu, Gou-Zhen Yang, Bi-Zhen Dong, Ming-Pin Chang, and Okan K. Ersoy. In this embodiment, the coherent light source 11 can be a gas laser, a diode laser, a vertical cavity surface emitting laser (VCSEL), a solid-state laser, a diode pumping solid-state laser or a dye laser, in which the gas laser is preferred. Furthermore, the type of the laser used in the embodiment can be a dual frequency or multi-frequency laser and a single-mode or multimode laser. The way of generating the fringe pattern 13 of sinusoidal intensity distribution by means of the phase diffractive optical element 12 will be described below, wherein the sinusoidal intensity distribution is represented by a formula:
I=I₀(1+y Cos φ(\vec{r}))
in which I₀ is the average light intensity, Y is a modulation and r is a spatial position vector that can be represented in the form of a rectangular coordinate apparatus \vec{r}=r(x,y), a polar coordinate apparatus \vec{r}=r(ρ,θ).

FIG. 2 is a schematic view of a design for forming a mathematical model of the phase diffractive optical element 12. Reference is made to FIGS. 1 and 2, an incident-light-beam plane 21 and an output-light-beam plane 22 are provided. The diffractive optical element is mounted on the incident-light-beam plane 21. An incident light beam 200 emitting from the coherent light source 11 is received by the incident-light-beam plane 21 which is then being modulated by means of the diffractive optical element. Thus, a fringe pattern 13 of sinusoidal intensity distribution is formed on the output-light-beam plane 22. A first wave function U1 exists at the incident-light-beam plane 21 used to be representative thereof, and can be represented by a formula:
U1(x1,y1)=A(x1,y1) exp [iθ(x1,y1)]

A second wave function U2 exists at the output-light-beam plane 22 used to be representative thereof, and can be represented by a formula:
U2(x2,y2)=A(x2,y2) exp [iθ(x2,y2)]

A transform function G exists between the first wave function U1 and the second wave function U2, and can be represented by a formula:
U2(x2,y2)=∫G(x2,y2; x1,y1)U2(x2,y2)dx1dy1=ĜU1

The aforesaid mathematical representation is a continuous integral function. To simplify calculation for the design, N1 sample points are taken from the incident-light-beam plane 21 while N2 sample points are taken from the output-light-beam plane 22. As such, the first wave function U1 and the second wave function U2 are converted into a matrix form and the transform function G becomes an N1-by-N2 matrix represented by a formula:

$${U}_{2 i} = {\sum }_{j - 1}^{N1} {G}_{ij} {U}_{1 j}$$

An error function D (not shown) defined by the first wave function U1, the second wave function U2 and the conversion function G exists and can be represented by a formula:
D≡∥U2-ĜU1∥

The error function D is optimized by an appropriative algorithm such as Gerchberg-Saxton algorithm, direct binary search algorithm, simulated annealing algorithm, genetic algorithm and Y-G algorithm.In this embodiment, the Y-G algorithm is adopted for optimally forming a patterned relief surface having a phase modulation function on the phase diffractive optical element 12.

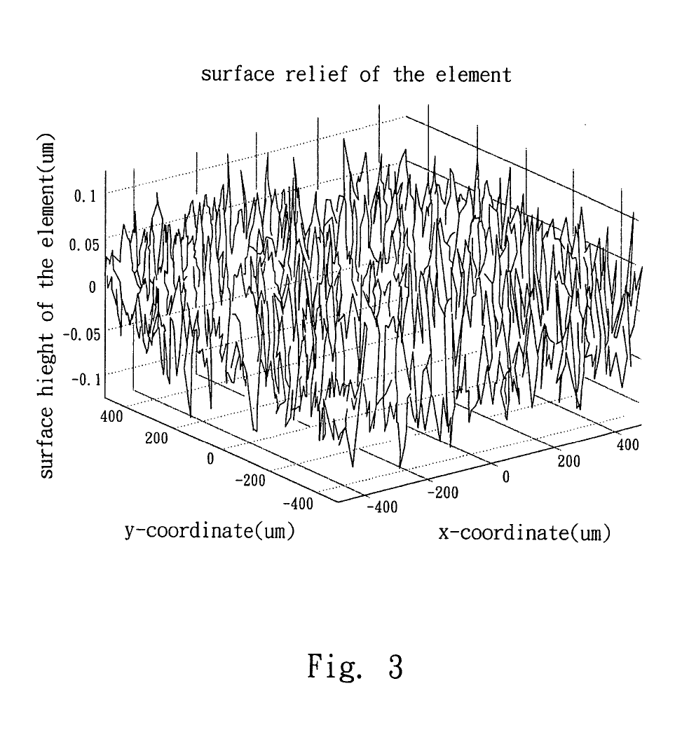

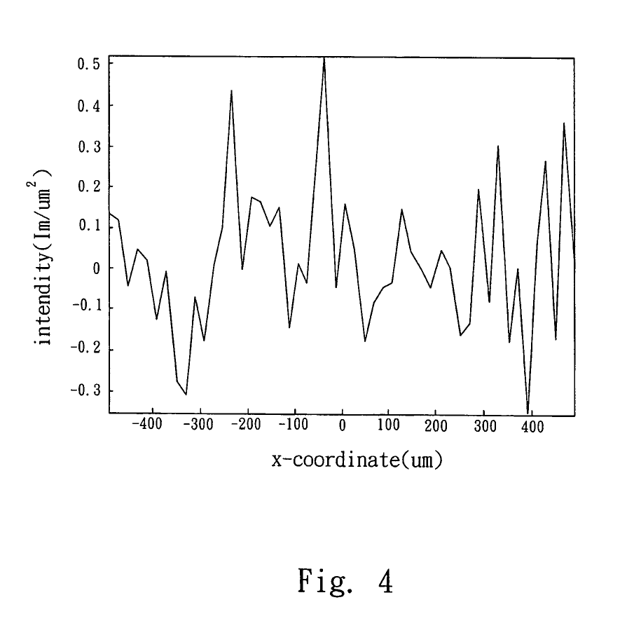

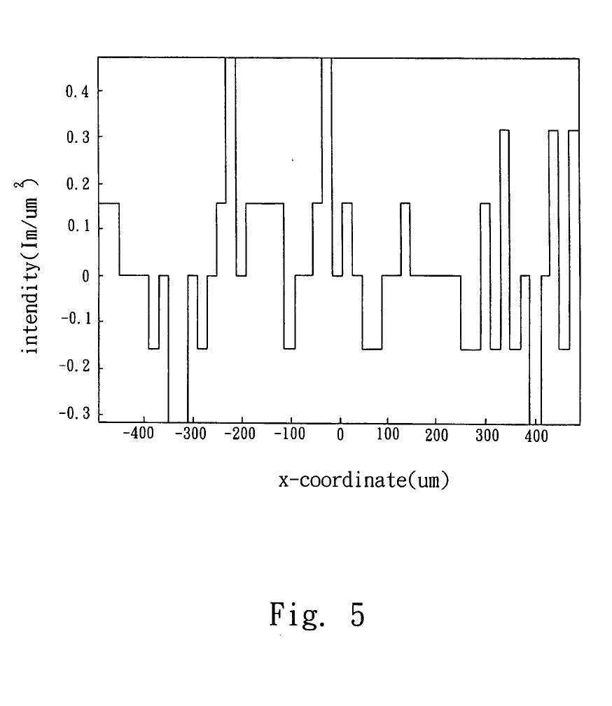

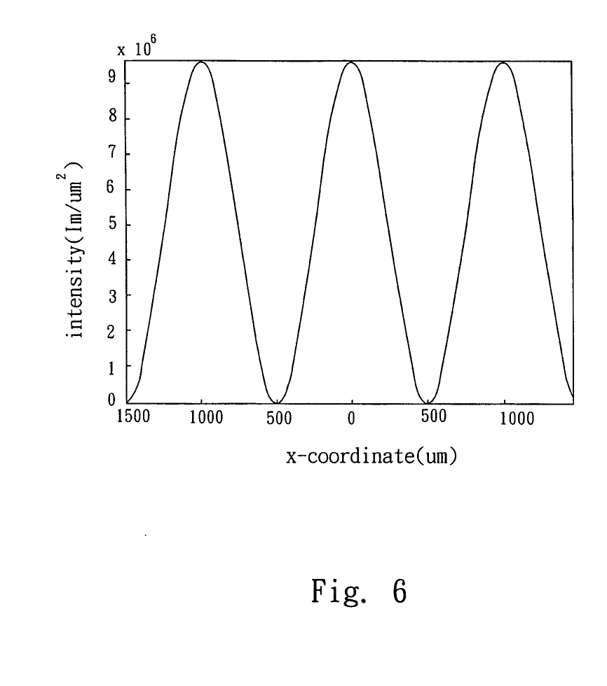

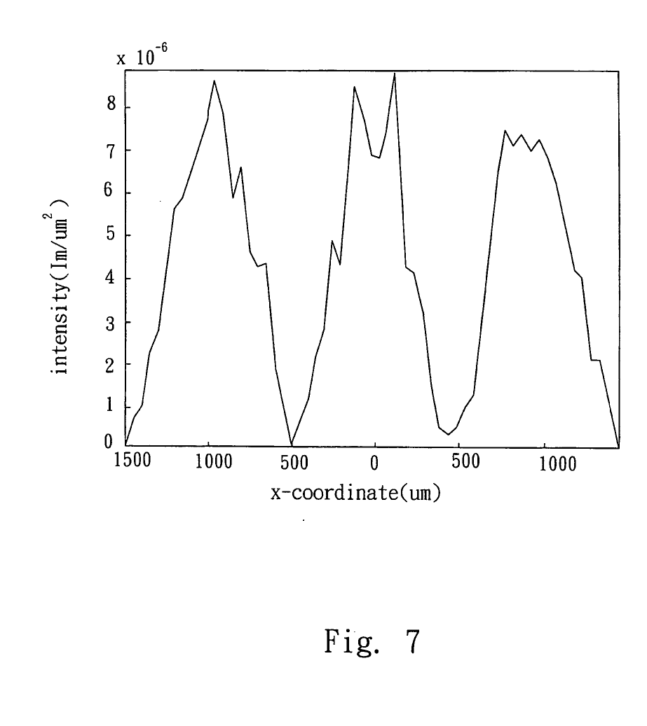

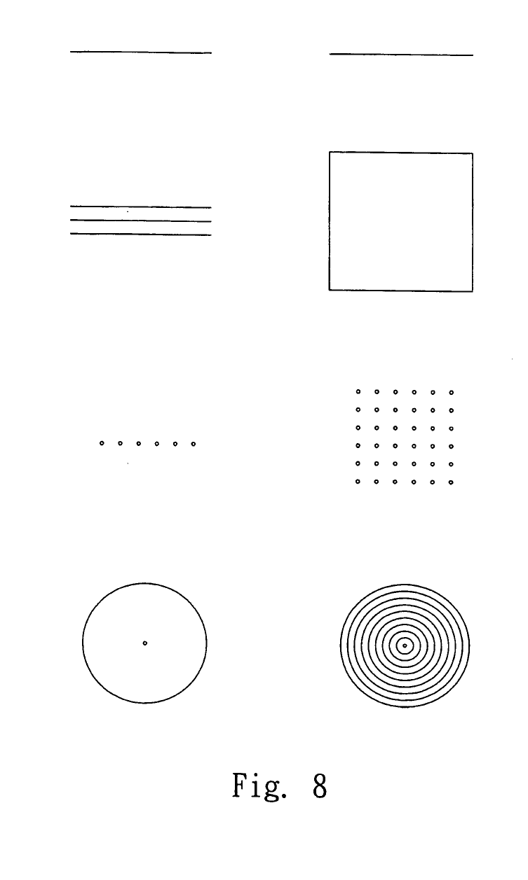

FIG. 3 illustrates a patterned relief surface as a result of a simulation, where the patterned relief surface is continuously formed on the output-light-beam plane according to the optimizing design. FIG. 4 is a cross-section view along the x-axis taken from the patterned relief surface 31 of FIG. 3. FIG. 5 is a cross-section view along the x-axis of the patterned relief surface formed in practice, where three steps of photolithography are used to result in eight quantization steps. FIG. 6 is a cross-section view of an optimal fringe pattern of sinusoidal intensity distribution along the x-axis. FIG. 7 is a cross-section view of a fringe pattern of sinusoidal intensity distribution along the x-axis as a result of a simulation. FIG. 8 schematically illustrates the shape of various fringe patterns of sinusoidal intensity distribution projected by the present invention. The fringe pattern of sinusoidal intensity distribution projected through the phase diffractive optical element 12 can be formed in the shape of linear line, dot, lattice, parallel lines, dotted line, single circle, concentric circles, cross or a single rectangle, and can be represented by a formula:
I=I₀(1+y Cos θ(\vec{r}))

In addition to the phase diffractive optical element 12, an amplitude diffractive optical element or a combination of the phase and the amplitude diffractive optical elements can be used to achieve the same or similar effects.

As described above, the present invention uses both the optical field distribution of the coherent light beam received by the incident-light-beam plane 21 and the optical field distribution of sinusoidal variation to design the relief construction of the diffractive optical element. Thus, the fringe pattern of sinusoidal intensity distribution is generated by means of the coherent light source and the diffractive optical element. Accordingly, a projection apparatus which is small-sized, light-weighted, high efficiency and capable of projecting a fringe pattern of sinusoidal intensity distribution is provided.

Although the present invention has been explained in relation to its preferred embodiments, it is to be understood that many other possible modifications and variations can be made without departing from the spirit and scope of the invention as hereinafter claimed.

1. An apparatus for generating a structured line having a sinusoidal intensity distribution, comprising:
a coherent light source for providing a coherently incident light beam; and
at least a diffractive optical element for shaping said coherent light beam to an output beam having a sinusoidally varying intensity distribution through a diffractive optical design;
wherein the at least one diffractive optical element is designed based on an optimal mathematical model, the optical mathematical model comprises a patterned relief surface of a phase diffractive optical element providing a phase modulation function, an incident-light-beam plane providing a first wave function and an output-light-beam plane providing a second wave function so that a transform function exists between said first wave function and said second wave function and a error function indicates a difference between said second wave function and the mathematical product of said first wave function and said transform function, and said error function is mathematically calculated by the optimal mathematical model to generate a patterned relief surface through which said coherent light beam is modulated to project a fringe pattern of sinusoidal intensity distribution onto said output-light-beam plane.

2. The apparatus of claim 1, wherein said sinusoidal intensity distribution is represented by a formula:
I=I₀(1+y Cos θ(\vec{r}))
in which is I₀ the average light intensity, Y is a modulation, \vec{r} is a spatial position vector that can be represented in the form of a rectangular coordinate apparatus \vec{r}=r(x,y), a polar coordinate apparatus \vec{r}=r(ρ,φ).

3. The apparatus claim 1, wherein said coherent light source is a gas laser.

4. The apparatus of claim 1, wherein said coherent light source is a diode laser.

5. The apparatus of claim 1, wherein said coherent light source is a vertical cavity surface emitting laser (VCSEL).

6. The apparatus of claim 1, wherein said coherent light source is a solid-state laser.

7. The apparatus of claim 6, wherein said coherent light source is a diode pumping solid-state laser.

8. The apparatus of claim 1, wherein said coherent light source is a dual frequency or multi-frequency laser.

9. The apparatus of claim 1, wherein said coherent light source is a dye laser.

10. The apparatus of claim 1, wherein said coherent light source is a single-mode or multimode laser.

11. The apparatus of claim 1, wherein said diffractive optical element is a phase relief diffractive optical element.

12. The apparatus of claim 1, wherein said diffractive optical element is an amplitude diffractive optical element.

13. The apparatus of claim 1, wherein said diffractive optical element is mixed type of diffractive optical element by combining a phase diffractive optical element and an amplitude optical element.

14. The apparatus of claim 1, wherein said diffractive optical element is a hologram optical element.

15. The apparatus of claim 1, wherein said diffractive optical element is a volume hologram optical element.

16. The apparatus of claim 1, wherein said diffractive optical element is a computer generated hologram.

17. The apparatus of claim 1, wherein said fringe pattern of sinusoidal intensity distribution is in the shape of line.

18. The apparatus of claim 1, wherein said fringe pattern of sinusoidal intensity distribution is in the shape of circle.

19. The apparatus of claim 1, wherein said fringe pattern of sinusoidal intensity distribution is in the shape of lattice.

20. The apparatus of claim 1, wherein said fringe pattern is represented by a formula:
I=I₀(1+y Cos θ(\vec{r})).
